(19) United States
(12) Patent Application Publication
(10) Pub. No.: US 2026/0101414 A1
(43) Pub. Date: Apr. 9, 2026

(54) SYSTEM AND METHODS FOR TRANSFERRING A CALL TO A PSAP

(71) Applicant: T-MOBILE INNOVATIONS LLC, Overland Park, KS (US)

(72) Inventors: Hang Hoi YAU, Sammamish, WA (US); Srinivasa Rao BODAPOTULA, Bellevue, WA (US); Terri BROOKS, Prosper, TX (US); Dinko DINKOV, Kirkland, WA (US); Jeanna GREEN, Lee's Summit, MO (US); Michael HOOKER, Seattle, WA (US); Ryan JENSEN, Monument, CO (US); Christopher JOUL, Bellevue, WA (US)

(21) Appl. No.: 18/907,800

(22) Filed: Oct. 7, 2024

(51) Int. Cl. H04W 76/50; H04W 4/90; H04W 12/06; H04W 76/19

(52) U.S. Cl. CPC H04W 76/50; H04W 4/90; H04W 12/06; H04W 76/19

(57) ABSTRACT

Systems and methods are provided for receiving a call from a wireless device at a wireless network, routing the call to a destination device, receiving, from the destination device, a request to establish an SOS mobile terminal (SOS MT) call for the call, transferring the received call from the destination device to a public safety answering point (PSAP).

### TECHNICAL BACKGROUND

Cellular phones, such as smartphones, are often used for contacting crisis services in a crisis situation. One such crisis service is a crisis hotline, which routes the received call to a crisis center. In some instances, the crisis center may decide to escalate the call to an emergency service contactable by a public safety answering point (PSAP). Contacting the PSAP by the crisis center requires coordination and work by multiple people, which can result in information being miscommunicated and delays in connection with the PSAP, leading to delays in aid being rendered to the caller.

### OVERVIEW

Exemplary embodiments described herein include systems and methods for transferring a call received at a destination, such as a crisis center, to a public safety answering point (PSAP) over a wireless network. An exemplary method includes receiving a call from a wireless device at a wireless network. Once the call is received, the method includes routing the call to a destination device. The method further includes receiving, from the destination device, a request to establish an SOS mobile terminal (SOS MT) call for the received call. Based on the received request, the method includes transferring the received call from the destination device to a PSAP.

Another example method includes receiving a call from a wireless device at a wireless network. The method further includes anchoring the call at an emergency call session control function (ECSCF). Once the call is anchored, the method includes determining a location of the wireless device. The received call is anchored at the E-CSCF server such that if the destination device escalates the call to transfer to emergency services, that the E-CSCF is already in communication with the wireless device and can replace the destination device with the PSAP by sending an invite message (such as an SOS re-invite message) to the PSAP while the call is still connected with the destination device. Based on the determined location, the method includes routing the call to a destination device. The method further includes adding a public safety answering point (PSAP) to the call. Upon the addition of the PSAP, the method includes re-establishing the call as an emergency call.

Further exemplary embodiments include a system for transferring a call to a public safety answering point (PSAP). The system includes a wireless network. The system additionally includes at least one electronic processor which may be coupled to a non-transitory computer readable medium. The non-transitory computer readable medium includes instruction which, when executed by a processor, causes the processor to receive a call request for a wireless device, route the call to a destination device, receive an invitation from a public safety answering point (PSAP) to transfer the received call from the destination device to the PSAP, and transfer the call to the PSAP.

### BRIEF DESCRIPTION OF THE DRAWINGS

FIG. 1 illustrates an exemplary system for wireless device communication in accordance with disclosed embodiments.

FIG. 2 illustrates an additional exemplary system for wireless device communication between a destination device and a PSAP in accordance with disclosed embodiments.

FIG. 3 illustrates an exemplary system for transferring a call to a PSAP in accordance with disclosed embodiments.

FIG. 4 illustrates an example method for transferring a call to a PSAP in accordance with disclosed embodiments.

FIG. 5 illustrates another example method for transferring a call to a PSAP in accordance with disclosed embodiments.

### DETAILED DESCRIPTION

Alternative help contact points, such as crisis centers, have become more commonplace alternatives to the use of public safety answering points (PSAPs), particularly for situations where mental health concerns are the primary reason for contact. A crisis hotline, such as the 988 Lifeline, may serve as a hub for crisis centers throughout the country. When a caller dials 988 on their wireless device or smartphone, the call is routed to a crisis center. In some examples, rough information location obtained from the wireless device can be used to locate a relatively nearby crisis center. In one example, the “rough” information can include using the area code of the user equipment (UE), such as a wireless device. The call is then connected to the determined crisis center, allowing the caller to receive the emergency crisis counseling services.

There are times when the crisis center determines that local emergency services should be contacted and dispatched. Once such a determination is made, the crisis center contacts emergency services, such as a PSAP, to begin the transfer process. Currently, having a crisis center contact a PSAP involves bringing a second crisis center worker in to make a separate call to the PSAP, with information from the caller to the crisis center being relayed from the worker who answered the initial call to the worker contacting the PSAP.

Exemplary embodiments described herein include systems and methods for transferring a call to a PSAP from a destination device such as a crisis center. For example, once the destination device determines that a PSAP should be brought in, a request to establish an emergency call, such as an SOS mobile terminal (SOS MT) can be transmitted. This may allow the PSAP to be contacted and brought into the initial call, forming a three-way conference call with the original wireless device and the destination device.

This action does not preclude a person from directly calling emergency services, such as a PSAP, in lieu of a crisis hotline, nor are crisis hotlines mandated to involve a PSAP in every call. Rather, the methods and system discussed herein allow for a streamlined engagement of a PSAP in situations where the crisis center determines that the situation is rising to the level of an emergency event, facilitating efficient communications and ensuring accurate information transfer to the PSAP.

The emergency event may be a mental health crisis, a suicide threat, a psychiatric event, or another similar emergency event.

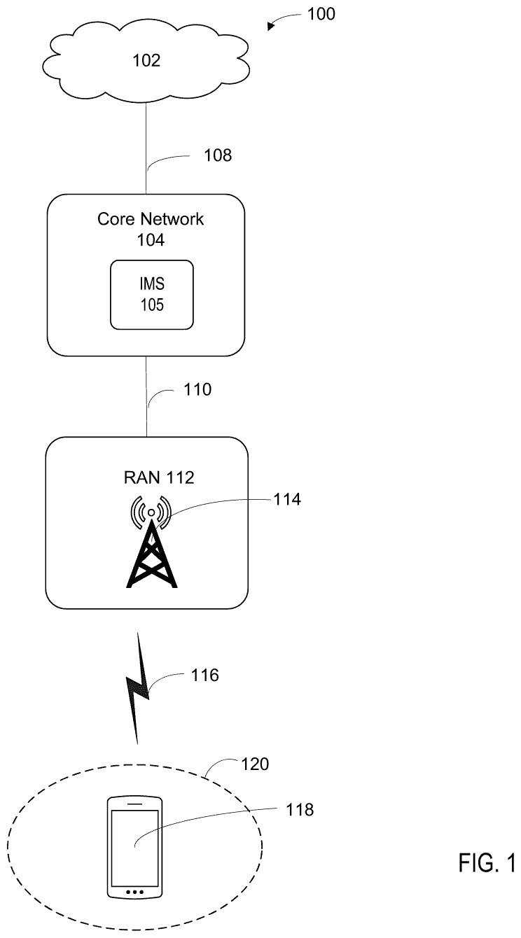

These and other examples will be described in greater detail below in relation to FIGS. 1-6.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless device 118, which may be an end-user wireless device and may operate within a coverage area 120. The wireless device 118 may communicate with an access node 114 within the RAN 112 over a communication link 116, which may for example be 4G NR communication links.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE). Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

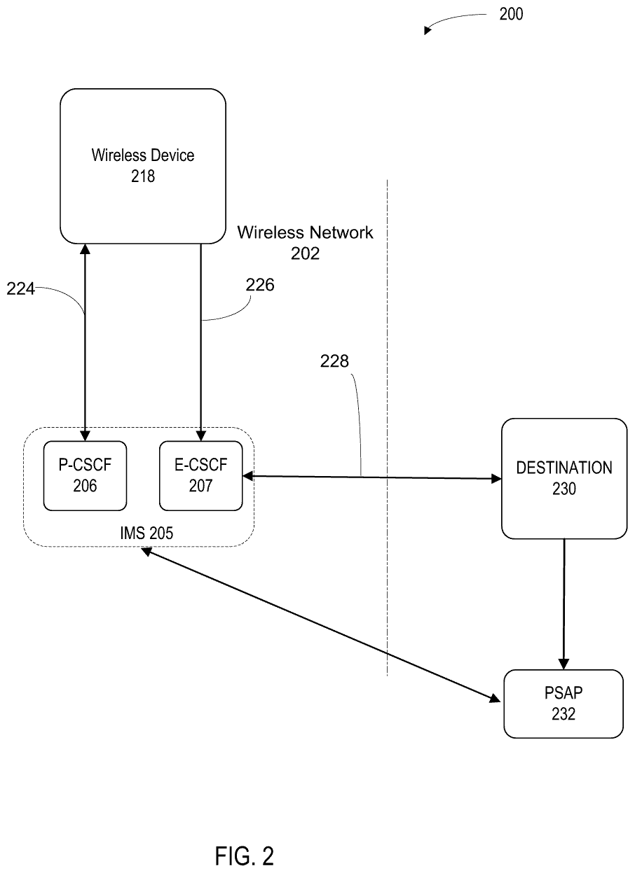

The core network 104 includes the IP Multimedia Subsystem (IMS) 105, which will be explained further in relation to FIG. 2. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless device 118.

Communication links 108 and 110 can use various communication media, such as air, space, metal, optical fiber, or some other signal propagation path—including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the end-user wireless device 118. Components of the RAN 112 may communicate directly with the core network 104 and others may communicate directly with the end user wireless device 118. The RAN 112 may provide services from the core network 104 to the end-user wireless device 118.

The RAN 112 includes an access node (or base station) 114, which may include one or more access nodes communicating with the end-user wireless device 118. It should be understood that the disclosed technology may also be applied to communication between an end-user wireless device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 118 may include any wireless device included in a wireless network. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless device 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for transferring a call to a PSAP may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

Now referring to FIG. 2, an exemplary system 200 for transferring a call to a PSAP is presented. System 200 includes a wireless device 218. Wireless device 218 may be the same as wireless device 218. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 205 includes servers, including a proxy call session control function (P-CSCF) 206 and an emergency call session control function {E-CSCF 207), shown, but it should be understood that there are many other types of IMS servers that are omitted for clarity. A proxy server, such as P-CSCF 206 receives a call request from a wireless device, as shown by arrow 224. Headers may be added to the call request in the form of SIP headers such as Resource Priority Header (RPH), X-MAV-RPH:911, Orig. ID, and Attestation-Info. The call request may then be forwarded to an emergency call management server such as E-CSCF 220 for further processing, as shown by arrow 226. E-CSCF 207 may query a gateway mobile location center (GMLC) for information about the destination network of the call. The GMLC returns information on a destination 230 that services the location of the wireless device that originated the call request. This information includes how to contact the destination 230. In some examples, the destination 230 may be a crisis hotline call number, which may be indicated by the wireless device 218 dialing, for example, a particular short code that is translated to a telephone number when the wireless device 218 transmits a call.

Once it is determined that the destination 230 is a crisis hotline, E-CSCF 207 transmits the call to the destination 230, shown at 228. The wireless device 218 is then in communication with a device at destination 230.

If destination 230 determines that an SOS mobile terminal (SOS MT) call should be established, the device at destination 230 will request an SOS MT call. This process is discussed further herein. Once the SOS MT call is established, the destination 230 contacts the PSAP 232 to establish a conference call between the wireless device 218, the destination 230, and the PSAP 232. Through this conference, the call between the wireless device 218 and the destination 230 may be transferred to the PSAP 232.

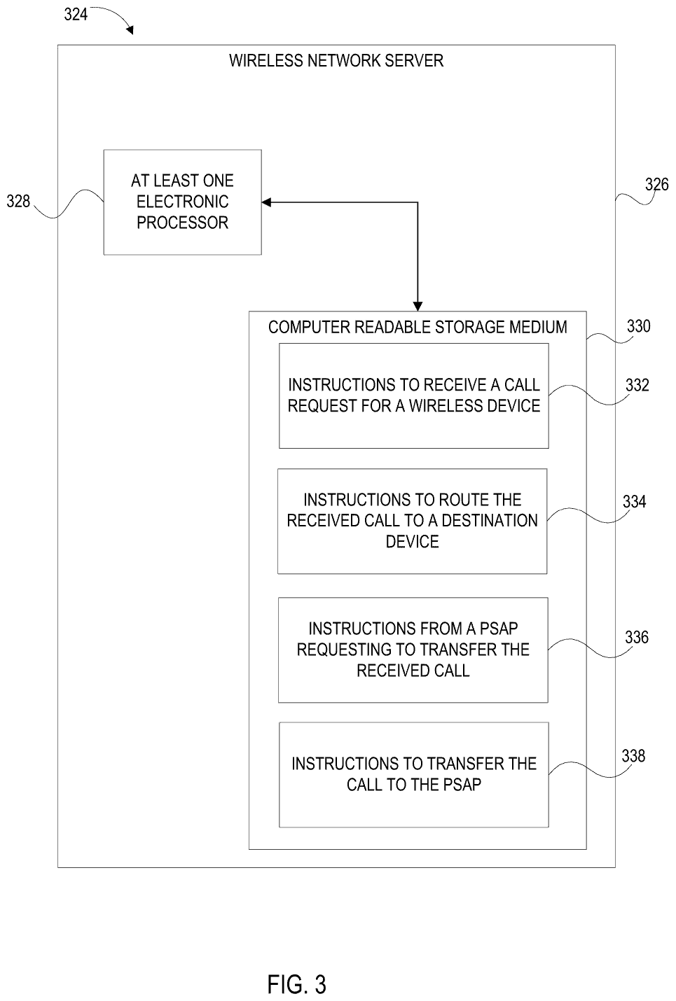

FIG. 3 illustrates an exemplary system 324 for transferring a call to a PSAP in accordance with disclosed embodiments. Processing system 324 includes a wireless network server 326. Wireless network server 326 includes at least one electronic processor 328 and computer readable storage medium 330, which can comprise a disk drive, flash drive, memory circuitry, or other memory device including, for example, a buffer. Computer readable storage medium 330 may include computer programs, firmware, or some other form of machine-readable instructions, such as instructions 332, 334, 336, and/or 338, which may instruct the at least one electric processor 328 to perform associated operations. Computer readable storage medium 330 including an operating system, utilities, drivers, network interfaces, applications, or some other type of software. The at least one electronic processor 328 may include circuitry to retrieve and execute instructions stored on computer readable storage medium 330, which may be internal or external to wireless network server 326. System 324 may further include other components such as a power management unit, a control interface unit, etc., which are omitted for clarity. System 324 may be included in various elements of the wireless network including an access node, P-CSCF, E-CSCF, or PSAP for example.

Instructions 332 may be executed by the at least one electronic processor 328 to receive a call request for a wireless device. The call request may be received at the wireless network server 326, which may be included within a larger wireless network system, such as the system discussed with respect to FIG. 1. The call request may come from a wireless device, such as wireless device 118 discussed with respect to FIG. 1 or wireless device 218, discussed with respect to FIG. 2.

Instructions 334 may be executed by the at least one electronic processor 328 to route the received call to a destination device. As discussed with respect to FIG. 2, the received call may be anchored at, for example, an E-CSCF server. The destination device may be associated with a crisis hotline and may not be associated with a PSAP.

Instructions 336 may be executed by the at least one electronic processor 328 to receive an invitation from a PSAP to transfer the received call from the destination device to the PSAP. The PSAP may invite the transfer of the received call from the destination device to the PSAP in response to the destination device beginning a conference call between the PSAP, the wireless device, and the destination device. In such examples, the PSAP may invite the transfer of the received call from the destination device, which is a non-PSAP associated device, to the PSAP in response to a determination that the call should be designated as an emergency call.

In some examples, processor 328 may further execute instructions to receive a location procedure request from the PSAP. Instructions to receive a location procedure request from the PSAP may occur concurrently with instructions 336 or prior to or after instructions 336. As used herein, a location procedure requests refers to a request to share a location of the wireless device with the PSAP. Upon receiving the location procedure request from the PSAP, processor 328 may execute instructions to determine a location of the wireless device. In some examples, the instructions to determine a location of the wireless device may include instructions to initiate a mobile terminated location request (MTLR) between the proxy server and the wireless device. The MTLR may be included within the location procedure request from the PSAP.

Once the location is determined, processor 328 may execute instructions to transmit the determined location to the PSAP. In some examples, the particular PSAP to which the determined location is transmitted may be based on the determined location. Said differently, once the location is determined, a PSAP that is geographically near the determined location may receive the determined location of the wireless device

Instructions 338 may be executed by the at least one electronic processor 328 to transfer the call to the PSAP from the destination device. In some examples, transferring the call to the PSAP from the destination device may first comprise establishing a conference call between the wireless device, the PSAP, and the destination device. Once a conference call is established, the destination device may be removed, allowing the wireless device to be connected with the PSAP directly. In some examples, transferring the call to the PSAP may further include designating the call as an emergency call.

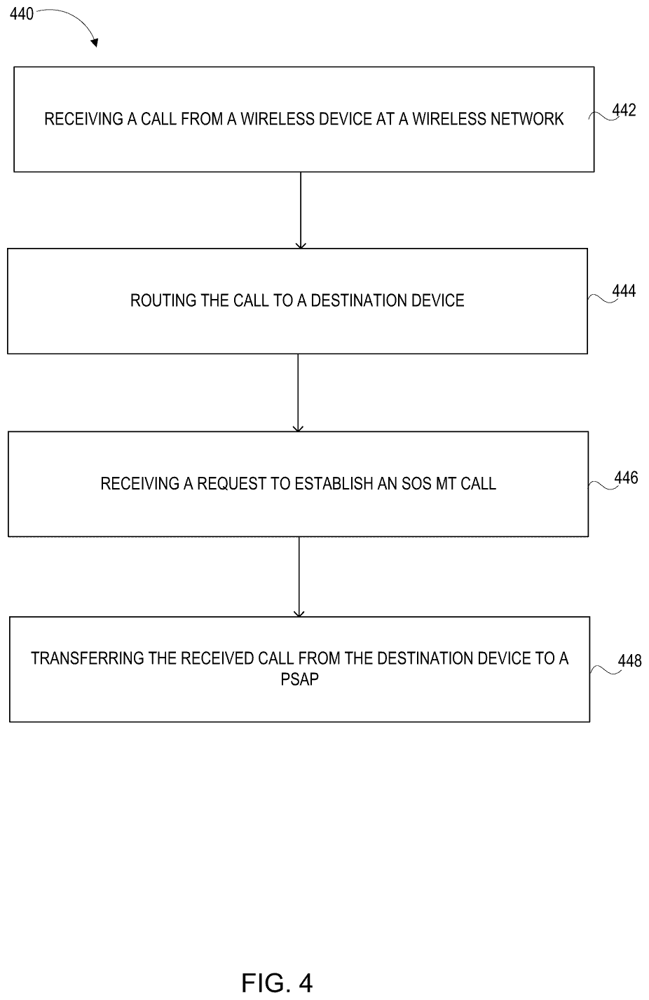

FIG. 4 illustrates an exemplary method 440 of transferring a call to a PSAP. Method 440 may be performed by any suitable combination of processors discussed herein, for example a processor contained in a wireless network server.

Method 440 begins in step 442 where a call is received from a wireless device at a wireless network. The wireless network may be hosted by a mobile network operation (MNO). In some examples, the call received from the wireless device may be a short code number. A short code number refers to a shortened telephone number, commonly between three and six digits, that can be used in lieu of a ten-digit long code. For example, the short code 988 can be used to connect with a crisis hotline, as opposed to the hotline's full ten-digit phone number. When a short code is received at the wireless network from the wireless device, the short code number is translated to a long code telephone number. The call is then completed using the translated telephone number.

Method 440 continues in step 444 where the call is routed to a destination device. The destination device may be associated with a crisis hotline and may not be a PSAP. In some examples, the particular destination device to which the call is routed may be determined based on a general location of the wireless device. For example, as discussed with respect to FIG. 1, the MNO may include at least one access point associated with a RAN, and the wireless device may interact with the access point. Because the access point is at a known geographic location, the general geographic location of the wireless device may be determined. Thus, a relatively local destination device may receive the routed call.

At step 446, method 440 may include receiving a request to establish an SOS mobile terminal (SOS MT) call for the call. The request may be received from the destination device and may be received in response to a determination made at the destination device, or by a user thereof. As used herein an SOS MT call refers to an emergency call from a wireless device, which includes additional information to aid an emergency call recipient in responding.

Receiving a request to establish an SOS MT call at step 446 may further comprise authenticating the wireless device to transmit emergency call information. The emergency call information may include precise location information and authenticating the wireless device to transmit emergency call information may permit the wireless device to transmit this information.

Once the wireless device is authenticated to transmit emergency call information, the method may further include determining an appropriate PSAP to route the call to based on the authentication. More particularly, because the emergency call information may include precise location information for the wireless device, a PSAP to which the emergency call can be routed to may be determined based on the location of the wireless device, on jurisdictional boundaries, or a combination thereof. In some examples, the location may be based on the area code of the UE. In other words, a PSAP that is geographically near the wireless device may have its location determined as an appropriate PSAP to route the emergency call to.

Method 400 continues in step 448 with transferring the received call from the destination device to a PSAP. Transferring the call to a PSAP may further comprise establishing a connection with the PSAP. In some examples, this connection is established from the destination device. Once the connection with the PSAP is established, a conference between the connection with the PSAP and the received call from the wireless device may be established. More particularly, when conferencing the connection with the PSAP, the connection with the PSAP may be designated as an emergency call. The wireless device may then be informed of the emergency call designation.

Once the wireless device is informed of the emergency call designation for the connection with the PSAP, the destination device may be removed from the conference. In this manner, the PSAP is permitted to take control of the call. Thus, the wireless device is connected with the PSAP.

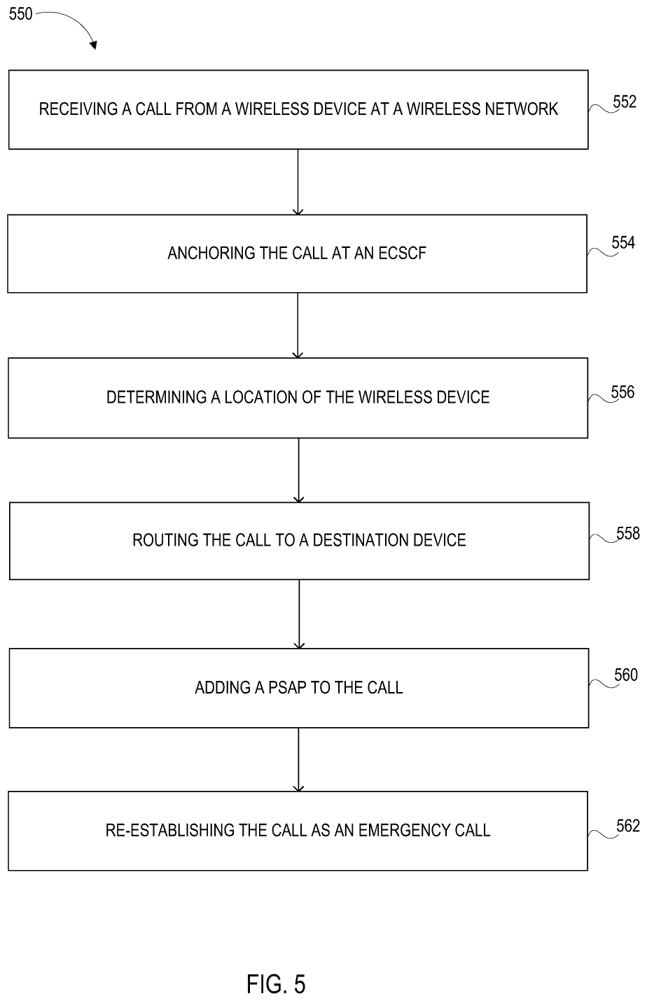

FIG. 5 illustrates an exemplary method 550 for transferring a call to a PSAP. Method 500 may be performed by any suitable combination of processors discussed herein, for example a processor contained in an emergency call management server, such as an E-CSCF server.

Method 550 begins in step 552 where a call is received at a wireless network from a wireless device. The wireless network may be hosted by a mobile network operator (MNO).

Method 550 continues in step 554 where the call is anchored at an emergency call session control function (E-CSCF). Anchoring a call at an E-CSCF may further include determining that the call is a crisis hotline call number. A crisis hotline call number may be a telephone number that routes to a particular non-emergency center. Based on the determined crisis hotline call number, a destination device to be contacted may be determined. The call may then be routed to the determined destination device.

At step 556, method 550 includes determining a location of the wireless device. The location of the wireless device may be determined based on the area code of the wireless device's associated telephone number, a location of an access point being used by the wireless device, or any other suitable means of determining a wireless device's location. Based on this determined wireless device location, method 550 may include, at step 558, routing the call to a destination device. More particularly, the call may be routed to a relatively local destination device, with the particular type of destination device being the destination device determined at step 554.

Method 550 continues in step 560 where a public safety answering point (PSAP) is added to the call. Adding a PSAP to the call further comprises contacting the PSAP, with the PSAP being contacted by the destination device. Once the PSAP is contacted, a conference call is created between the wireless device, the destination device, and the PSAP. When the PSAP is added to the call at a conference, the PSAP may be authenticated at the wireless device. More particularly, a uniform resource identifier (URI) may be transmitted to the wireless device. As used herein, a URI refers to a set of characters used to identify a resource. In the present example, the URI may include information to identify the PSAP that is part of the conference call.

In addition, the PSAP may further transmit an invitation to the wireless device. The invitation may include a mobile terminated location request (MTLR) that, when received by the wireless device, may enable the wireless device to share its precise location with the PSAP, allowing the PSAP to dispatch appropriate services to the location. Moreover, as part of the MTLR and the overall step of adding a PSAP to the call, the call may be designated as an emergency call.

Method 550 continues in step 562 with the re-establishment of the call as an emergency call. Once the conference call is established, the PSAP is authenticated, and the call is designated as an emergency call, the destination device may drop off or remove itself from the call. Thus, the call is re-established as an emergency call between only the PSAP and the wireless device.

In some embodiments, methods 440 and 550 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
receiving a call from a wireless device at a wireless network;
routing the call to a destination device;
receiving, from the destination device, a request to establish an SOS mobile terminal (SOS MT) call for the call; and
transferring the received call from the destination device to a public safety answering point (PSAP).

2. The method of claim 1, wherein receiving a call from a wireless device further comprises:
translating a received short code number to a telephone number; and
completing the call using the telephone number.

3. The method of claim 1, wherein receiving a request to establish an SOS MT call further comprises:
authenticating the wireless device to transmit emergency call information; and
determining a location of a PSAP based on the authentication of the wireless device, wherein the location of the PSAP is further determined based on the location of the wireless device.

4. The method of claim 1, wherein transferring the call to a PSAP further comprises:
establishing a connection with the PSAP;
conferencing the connection with the PSAP and the received call from the wireless device; and
permitting the PSAP to take control of the received call.

5. The method of claim 4, wherein conferencing the connection with the PSAP and the received call further comprises:
designating the connection with the PSAP as an emergency call;
informing the wireless device of the emergency call designation; and
removing the destination device.

6. The method of claim 1, wherein the wireless network is hosted by a mobile network operator (MNO).

7. The method of claim 1, wherein the destination device is associated with a crisis hotline and is not a PSAP.

8. A method, comprising:
receiving a call from a wireless device at a wireless network;
anchoring the call at an emergency call session control function (E-CSCF);
determining a location of the wireless device;
routing the call to a destination device based on the determined location;
adding a public safety answering point (PSAP) to the call; and
re-establishing the call as an emergency call.

9. The method of claim 8, wherein anchoring the call at an ECSCF further comprises:
determining that the call is a crisis hotline call number;
determining a destination device to be contacted based on the determined crisis hotline call number; and
routing the call to the destination device.

10. The method of claim 8, wherein adding a PSAP to the call further comprises:
contacting the PSAP;
creating a conference call between the wireless device, the destination device, and the PSAP; and
authenticating the PSAP at the wireless device.

11. The method of claim 10, wherein adding a PSAP to the call further comprises designating the call as an emergency call.

12. The method of claim 10, wherein authenticating the PSAP at the wireless device further comprises transmitting a uniform resource identifier (URI) to the wireless device, wherein the URI includes information to identify the PSAP.

13. The method of claim 12, further comprising transmitting an invitation from the PSAP to the wireless device that comprises a mobile terminated location request (MTLR) request to the wireless device.

14. The method of claim 8, wherein the wireless network is hosted by a mobile network operator (MNO).

15. The method of claim 14, wherein the destination device is associated with a crisis hotline and is not a PSAP.

16. A system, the system comprising:
a wireless network server, including at least one electronic processor configured for executing instructions to perform operations including:
receiving a call request for a wireless device at the wireless network server;
routing the received call to a destination device;
receiving an invitation from a public safety answering point (PSAP) to transfer the received call from the destination device to the PSAP; and
transferring the call to the PSAP.

17. The system of claim 16, the operations further comprising:
receiving a location procedure request from the PSAP;
determining a location of the wireless device; and
transmitting the determined location to the PSAP.

18. The system of claim 16, the operations further comprising designating the call as an emergency call responsive to transferring the call to the PSAP.

19. The system of claim 16, the operations further comprising initiating a mobile terminated location request (MTLR) between the proxy server and the wireless device.

20. The system of claim 16, wherein the destination device is associated with a crisis hotline and is not a PSAP.
